(19) United States
(12) Patent Application Publication
(10) Pub. No.: US 2024/0033947 A1
(43) Pub. Date: Feb. 1, 2024

(54) ROBOT HAND AND ROBOT DEVICE

(71) Applicant: SINTOKOGIO, LTD., Nagoya-shi (JP)

(72) Inventors: Yoshikane TANAAMI, Nagoya-shi (JP); Miyuki HAYASHI, Nagoya-shi (JP); Takahiro KOKAWAJI, Nagoya-shi (JP)

(73) Assignee: SINTOKOGIO, LTD., Nagoya-shi (JP)

(21) Appl. No.: 18/346,937

(22) Filed: Jul. 5, 2023

(30) Foreign Application Priority Data
Jul. 29, 2022 (JP) 2022-122042

(51) Int. Cl. B25J 15/02; B25J 13/08; B25J 9/16

(52) U.S. Cl. CPC B25J 15/0246; B25J 15/0206; B25J 13/082; B25J 9/163; B25J 9/1612

(57) ABSTRACT

A robot hand includes a plurality of fingers, a first electromagnet, a second electromagnet, and a movable part configured to be movable between the first electromagnet and the second electromagnet. Each of the plurality of fingers includes a gripping part configured to grip an object, a cam follower configured to rotate around a rotating shaft in accordance with movement of the movable part.

This Nonprovisional application claims priority under 35 U.S.C. § 119 on Patent Application No. 2022-122042 filed in Japan on Jul. 29, 2022, the entire contents of which are hereby incorporated by reference.

### TECHNICAL FIELD

The present invention relates to a robot hand and a robot device including the robot hand.

### BACKGROUND ART

Conventionally, there exists a robot configured to grip a workpiece by driving a plurality of fingers (for example, see Patent Literature 1). The robot disclosed in Patent Literature 1 includes a tactile sensor provided on a gripping surface of each of the fingers and controls, on the basis of detection values from the tactile sensors, a gripping force at the time when a workpiece is gripped.

### CITATION LIST

### Patent Literature

[Patent Literature 1]
Japanese Patent Application Publication Tokukai No. 2022-90902

### SUMMARY OF INVENTION

### Technical Problem

The robot disclosed in Patent Literature 1 needs to be provided with a motor for adjusting the gripping force and thus has a complicated configuration. This unfortunately makes it difficult to reduce a size of the device.

It is an object of an aspect of the present invention to provide a robot hand and a robot device each of which has a simple and compact configuration.

### Solution to Problem

A robot hand in accordance with an aspect of the present invention includes: a plurality of fingers; a first electromagnet; a second electromagnet; and a movable part. The second electromagnet faces the first electromagnet. The movable part is made of a magnetic material and is configured to be movable between the first electromagnet and the second electromagnet. Each of the plurality of fingers includes a gripping part configured to grip an object and a rotating part configured to rotate around a rotating shaft in accordance with movement of the movable part. The gripping part is located at a tip of the finger. The rotating part is provided at an end portion on an opposite side of the finger from the gripping part. The rotating shaft is disposed at a position apart from the end portion of the finger by a predetermined distance.

The gripping parts of the respective plurality of fingers perform a closing operation in which the rotating parts rotate in a first direction in accordance with movement of the movable part toward the first electromagnet with magnetic attraction of the first electromagnet, so that the gripping parts move closer to each other. In addition, the gripping parts perform an opening operation in which the rotating parts rotate in a second direction opposite to the first direction in accordance with movement of the movable part toward the second electromagnet with magnetic attraction of the second electromagnet, so that the gripping parts move away from each other.

According to the robot hand, it is possible to cause the gripping parts to perform the closing operation by causing the rotating parts to rotate in a first direction in accordance with movement of the movable part toward the first electromagnet with magnetic attraction of the first electromagnet. In addition, it is possible to cause the gripping parts to perform the opening operation by causing the rotating parts to rotate in the second direction in accordance with the movement of the movable part toward the second electromagnet with magnetic attraction of the second electromagnet. This makes it possible to adjust, with a simple and compact configuration, a gripping force with which the gripping parts grip an object.

### Advantageous Effects of Invention

An aspect of the present invention makes it possible to achieve a robot hand and a robot device each of which has a simple and compact configuration.

### BRIEF DESCRIPTION OF DRAWINGS

FIG. 1 is a view schematically illustrating a configuration of a robot system in accordance with an embodiment of the present disclosure.

FIG. 2 is a block diagram illustrating a configuration of the robot system in accordance with the embodiment.

FIG. 3 is a plan view illustrating a tactile sensor included in the robot device illustrated in FIG. 1.

FIG. 4 is a perspective view showing directions of forces and of moments detected by a force sensor included in the robot device illustrated in FIG. 1.

FIG. 5 is a view showing a closing operation performed by fingers of the robot device illustrated in FIG. 1.

FIG. 6 is a view showing an opening operation performed by fingers of the robot device illustrated in FIG. 1.

FIG. 7 is a flowchart showing an example of a flow of control of a gripping force with which the robot device illustrated in FIG. 1 grips an object.

### DESCRIPTION OF EMBODIMENTS

### Outlines of Embodiments of Present Disclosure

First, the following will describe outlines of embodiments of the present disclosure.

(Item 1) A robot hand including: a plurality of fingers; a first electromagnet; a second electromagnet facing the first electromagnet; and a movable part made of a magnetic material and configured to be movable between the first electromagnet and the second electromagnet, the plurality of fingers including: respective gripping parts located at tips of the fingers and configured to grip an object; and respective rotating parts configured to rotate around rotating shafts in accordance with movement of the movable part, the respective gripping parts of the plurality of fingers being configured to perform: a closing operation in which the rotating parts rotate in a first direction in accordance with movement of the movable part toward the first electromagnet with magnetic attraction of the first electromagnet, so that the gripping parts move closer to each other; and an opening operation in which the rotating parts rotate in a second direction opposite to the first direction in accordance with movement of the movable part toward the second electromagnet with magnetic attraction of the second electromagnet, so that the gripping parts move away from each other.

According to the above configuration, it is possible to cause the gripping parts to perform the closing operation by causing the rotating parts to rotate in the first direction in accordance with the movement of the movable part toward the first electromagnet with magnetic attraction of the first electromagnet. In addition, it is possible to cause the gripping parts to perform the opening operation by causing the rotating parts to rotate in the second direction in accordance with the movement of the movable part toward the second electromagnet with magnetic attraction of the second electromagnet. This makes it possible to achieve a robot hand having a simple and compact configuration.

(Item 2) The robot hand according to Item 1, further including: a first fixing part where the first electromagnet is disposed; a second fixing part where the second electromagnet is disposed; a first elastic member provided at the first fixing part and configured to press the movable part in a direction in which the movable part moves away from the first electromagnet; and a second elastic member provided at the second fixing member and configured to press the movable part in a direction in which the movable part moves away from the second electromagnet.

According to the above configuration, it is possible to dispose the movable part at a predetermined neutral position by pressing the movable part with use of the first elastic member and the second elastic member. This makes it possible to maintain, with a simple configuration, the positions of the fingers in a neutral state.

(Item 3) The robot hand according to Item 1 or 2, wherein the movable part has a concavity where the rotating parts are held.

According to the above configuration, the rotating parts are held in the concavity of the movable part, so that it is possible to prevent the rotating parts from coming off the movable part when the movable part moves.

(Item 4) A robot device including: the robot hand according to any one of Items 1 to 3; and a control section configured to control a magnitude of current flowing through the first electromagnet or the second electromagnet, the control section controlling a degree of opening between the gripping parts by (i) controlling the magnitude of current flowing through the first electromagnet to cause the movable part to move toward the first electromagnet, thereby causing the gripping parts to perform the closing operation and (ii) controlling the magnitude of current flowing through the second electromagnet to cause the movable part to move toward the second electromagnet, thereby causing the gripping parts to perform the opening operation.

According to the above configuration, the control section controls the magnitude of the current flowing through the first electromagnet or the second electromagnet and causes the gripping parts to perform the closing operation or the opening operation, so that it is possible to accurately control the degree of opening between the gripping parts.

(Item 5) The robot device according to Item 4, further including a sensor configured to be capable of detecting at least one selected from the group consisting of a gripping force with which the gripping parts grip the object, forces acting on the robot hand, and moments acting on the robot hand, the control section controlling the magnitude of current flowing through the first electromagnet or the second electromagnet on the basis of a detection result from the sensor.

According to the above configuration, the control section makes it possible to more accurately control the degree of opening between the gripping parts by controlling the magnitude of the current flowing through the first electromagnet or the second electromagnet on the basis of a detection result from the sensor.

(Item 6) The robot device according to Item 5, wherein: the sensor is a tactile sensor disposed in each of the gripping parts and configured to detect the gripping force; and the control section controls the magnitude of current flowing through the first electromagnet or the second electromagnet on the basis of a magnitude of the gripping force detected by the tactile sensor.

According to the above configuration, it is possible to appropriately grip the object, since the control section controls the magnitude of the current flowing through the first electromagnet or the second electromagnet on the basis of the magnitude of the gripping force detected by the sensor.

(Item 7) The robot device according to Item 6, wherein the control section controls the magnitude of current flowing through the first electromagnet or the second electromagnet so that a magnitude of the gripping force detected by the tactile sensor falls within a predetermined range.

According to the above configuration, it is possible to stably grip the object, since the control section controls the magnitude of the current flowing through the first electromagnet or the second electromagnet so that the magnitude of the gripping force detected by each of the tactile sensors falls within a predetermined range.

(Item 8) The robot device according to any one of Items 5 to 7, wherein the control section calculates a weight of the object on the basis of a detection result from the sensor.

According to the above configuration, it is possible to measure a weight of the object when the gripping parts lift the object, since the control section can calculate the weight of the object on the basis of a detection result from the sensor. This eliminates the need for gripping the object only in order to measure the weight of the object, and thus it is possible to reduce the possibility that the fingers and/or the object may break due to the increased number of times of gripping the object.

(Item 9) The robot device according to any one of Items 5 to 8, further including a gripped state inference section configured to infer a gripped state of the object on the basis of a gripped state inference trained model and a detection result from the sensor, the gripped state inference trained model being obtained through machine learning using, as training data, a relationship between a detection result from the sensor and the gripped state of the object gripped by the gripping parts, the control section adjusting (i) a gripping position where the gripping parts grip the object and (ii) the degree of opening between the gripping parts, by controlling the magnitude of current flowing through the first electromagnet or the second electromagnet on the basis of the gripped state of the object inferred by the gripped state inference section.

According to the above configuration, it is possible to accurately control the fingers in accordance with the gripped state of the object, since the control section adjusts (i) the gripping position where the gripping parts grip the object and (ii) the degree of opening between the gripping parts on the basis of the gripped state of the object that has been inferred by inputting a detection result from the sensor into the gripped state inference trained model.

(Item 10) The robot device according to any one of Items 5 to 8, further including a type inference section configured to infer a type of the object on the basis of a type inference trained model and a detection result from the sensor, the type inference trained model being obtained through machine learning using, as training data, a relationship between a detection result from the sensor and the type of the object, the control section adjusting (i) a gripping position where the gripping parts grip the object; and (ii) the degree of opening between the gripping parts by controlling the magnitude of current flowing through the first electromagnet or the second electromagnet on the basis of the type of the object inferred by the type inference section.

According to the above configuration, it is possible to appropriately grip the object in accordance with the type of the object, since the control section adjusts (i) the gripping position where the gripping parts grip the object and (ii) the degree of opening between the gripping parts on the basis of the type of the object that has been inferred by inputting a detection result from the sensor into the type inference trained model.

(Item 11) The robot device according to any one of Items 5 to 10, wherein the control section adjusts (i) a gripping position where the gripping parts grip the object and (ii) the degree of opening between the gripping parts, on the basis of an output obtained by inputting a detection result from the sensor into a control trained model obtained through machine learning.

According to the above configuration, it is possible to appropriately grip the object with use of the gripping parts since the control section adjusts (i) the gripping position where the gripping parts grip the object and (ii) the degree of opening between the gripping parts on the basis of the output obtained by inputting a detection result from the sensor into the control trained model.

### Example of Embodiment of Present Disclosure

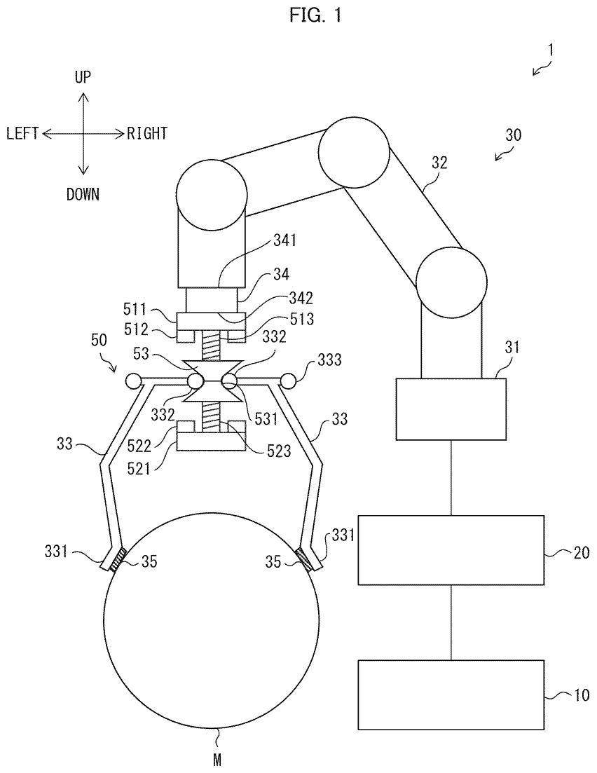

With reference to FIGS. 1 to 7, the following will describe a robot system 1 in accordance with an embodiment of the present disclosure.

[Configuration of Robot System]

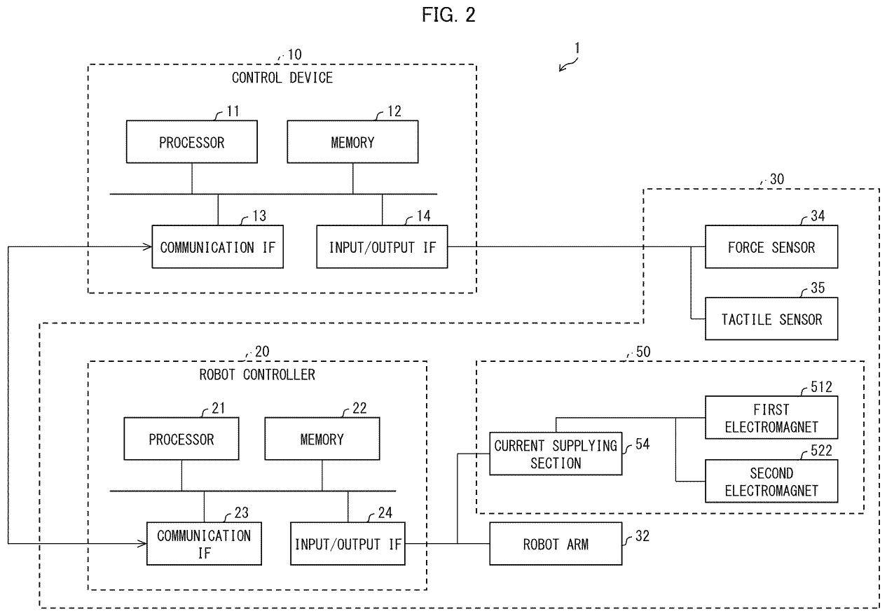

The following will discuss a configuration of the robot system 1 with reference to FIGS. 1 and 2. FIG. 1 is a view schematically illustrating the configuration of the robot system 1. FIG. 2 is a block diagram showing the configuration of the robot system 1.

As illustrated in FIGS. 1 and 2, the robot system 1 includes a control device 10 and a robot device 30. The robot system 1 is a system configured to infer, for example, a type of an object M gripped by the robot device 30 and a gripped state of the object M.

[Configuration of Robot Device]

The robot device 30 includes a base 31, a robot arm 32, a robot hand 50, a robot controller 20, a force sensor 34, and tactile sensors 35. The base 31 is disposed on a placement surface, such as a floor. Note that, instead of the base 31, an automatic conveyance device, such as an automatic guides vehicle (AGV), may be used. In this case, the robot device 30 can be caused to travel along a predetermined route.

The robot arm 32 is an articulated robot arm and has four arms. Each of the arms has a base end portion rotatably connected to the base 31 or an end portion of another arm. Rotation of the arms at respective connection parts is controlled on the basis of control performed by the robot controller 20, so that a trajectory of the robot arm 32 is controlled. Note that the robot arm 32 may be provided with a camera, and image information from the camera may be used for controlling a posture of the robot arm 32.

The robot hand 50 includes fingers 33, a first fixing part 511, a first electromagnet 512, a first elastic member 513, a second fixing part 521, a second electromagnet 522, a second elastic member 523, a movable part 53, and a current supplying section 54.

As illustrated in FIG. 1, the plurality of (for example, two) fingers 33 are provided. The following description of the present embodiment takes, as an example, a case where the two fingers 33 are provided. Note that the present disclosure is not limited to the configuration in which the two fingers 33 are provided.

Each of the fingers 33 has three bent portions and is provided with a gripping part 331. Each of fingers 33 is attached to the robot arm 32 via the movable part 53, the first elastic member 513, the first fixing part 511, and the force sensor 34.

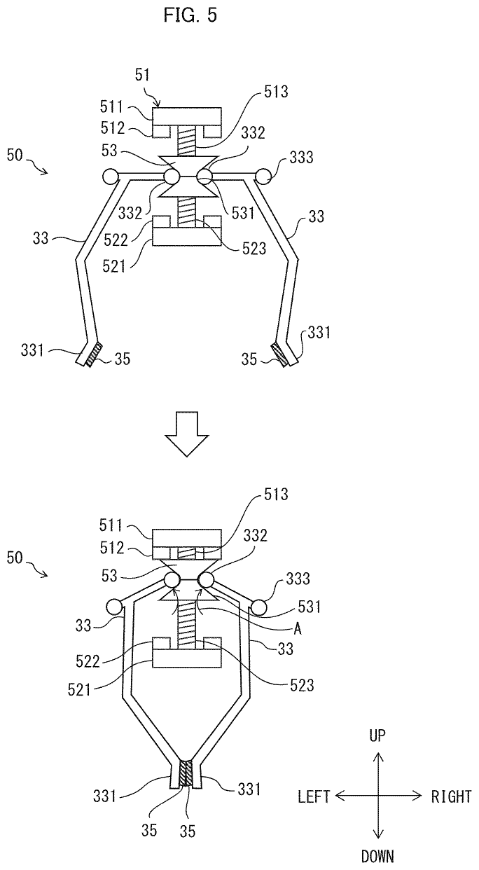

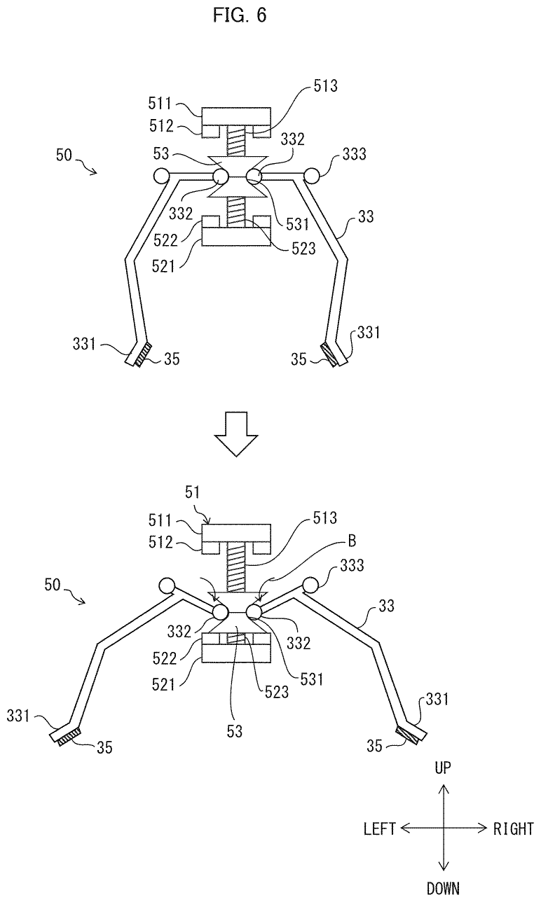

The gripping part 331 is located at a tip of each of the fingers 33. The fingers 33 perform opening and closing operations under the control performed by the robot controller 20. The opening and closing operations of the fingers 33 include a closing operation (see FIG. 5) in which the gripping parts 331 move closer to each other and an opening operation (see FIG. 6) in which the gripping parts 331 move away from each other. The gripping parts 331 move closer to each other in accordance with the closing operation of the fingers 33, so that the gripping parts 331 can grip the object M.

Cam followers 332 are provided at respective end portions of the fingers 33 on sides opposite to the gripping parts 331. The cam followers 332 rotate around respective rotating shafts 333 in accordance with movement of the movable part 53 toward the first electromagnet 512 or movement of the movable part 53 toward the second electromagnet 522. The cam follower 332 is an example of a rotating part. Note that the rotating part is not limited to a configuration (described later) of the cam follower 332. The rotating part only needs to have a configuration in which the rotating part rotates around the rotating shaft 333 in accordance with movement of the movable part 53 in an up-and-down direction.

Each of the rotating shafts 333 is disposed at a position apart from the above end portion of the finger 33 by a predetermined distance. In the present embodiment, the “predetermined distance” is a distance, in the finger 33 illustrated in FIG. 1, between a position where each of the cam followers 332 is provided and a first bent portion at which the finger 33 bends downward. It is assumed that adjusting the predetermined distance can result in adjustment of a gripping force that is generated at the gripping parts 331 in accordance with the movement of the movable part 53. The predetermined distance is set in consideration of a weight, a size and the like of the object M.

The first fixing part 511 is a thin member having a cylindrical shape and is fixed to the robot arm 32 via the force sensor 34. The first fixing part 511 has a lower surface on which the first electromagnet 512 having an annular shape is disposed, as illustrated in FIGS. 5 and 6.

The first electromagnet 512 has a coil, a magnetic core and the like which are not illustrated. When current flows through the coil of the first electromagnet 512, a magnetic force is generated. The robot controller 20 switches the coil between a state in which current passes through the coil and a state in which no current passes through the coil, so that the first electromagnet 512 is switched between a magnetized state and a non-magnetized state.

The first electromagnet 512 is magnetized, being supplied with current from a power source (not illustrated) by the current supplying section 54. When the first electromagnet 512 is magnetized, magnetic attraction of the first electromagnet 512 causes the movable part 53 to move toward the first electromagnet 512.

The second fixing part 521 is disposed below the first fixing part 511. The second fixing part 521 is a thin member having a cylindrical shape. The second fixing part 521 has an upper surface on which the second electromagnet 522 having an annular shape is disposed.

The second electromagnet 522 has a coil, a magnetic core and the like which are not illustrated. When current flows through the coil of the second electromagnet 522, a magnetic force is generated. The robot controller 20 switches the coil between a state in which current passes through the coil and a state in which no current passes through the coil, so that the second electromagnet 522 is switched between a magnetized state and a non-magnetized state.

The second electromagnet 522 is magnetized, being supplied with current by the current supplying section 54. When the second electromagnet 522 is magnetized, magnetic attraction of the second electromagnet 522 causes the movable part 53 to move toward the second electromagnet 522.

The movable part 53 is configured to be movable between the first electromagnet 512 and the second electromagnet 522. The movable part 53 is shaped such that upper surfaces of two truncated cone-shaped members are attached to each other. The movable part 53 is made of a magnetic material, such as a metal, for example, iron. The movable part 53 has a concavity 531. As illustrated in FIG. 1, the concavity 531 corresponds to a narrow portion of the movable part 53 and the cam followers 332 abutting on the concavity 531 is held in the concavity 531. Note that the size of the movable part 53 in the up-and-down direction can be set as appropriate in accordance with, for example, intended use of the robot device 30 and a maximum size of the object M.

More specifically, each of the cam followers 332 is constituted by an outer wheel, a needle roller, an inner wheel, a shaft and the like which are not illustrated. The outer wheel abuts on the concavity 531. The shaft is connected to the finger 33. When the movable part 53 moves in the up-and-down direction, the cam followers 332 roll while the outer wheels of the cam followers 332 abut on the concavity 531 and the cam followers 332 are held in the concavity 531. This causes the fingers 33 connected to the shafts of the cam followers 332 to rotate around the respective rotating shafts 333.

Specifically, as illustrated in a lower diagram of FIG. 5, when the movable part 53 moves toward the first electromagnet 512, the cam followers 332 rotate in a first direction (see arrows A in the lower diagram of FIG. 5). The closing operation of the gripping parts 331 is performed in accordance with such rotation of the cam followers 332 in the first direction.

In contrast, as illustrated in a lower diagram of FIG. 6, when the movable part 53 moves toward the second electromagnet 522, the cam followers 332 rotate in a second direction (see arrows B in the lower diagram of FIG. 6). The opening operation of the gripping parts 331 is performed in accordance with such rotation of the cam followers 332 in the second direction. Such a configuration makes it possible to adjust, with a simple and compact configuration, the gripping force with which the gripping parts 331 grip the object M.

Further, reducing the size of the robot hand 50 can reduce a weight of the robot hand 50, and accordingly, the gripping parts 331 of the robot device 30 can grip a heavier object M.

The first elastic member 513 is disposed on an inner side of the first electromagnet 512 on the lower surface of the first fixing part 511. The first elastic member 513 is, for example, a coil spring.

The first elastic member 513 has one end portion connected to the first fixing part 511. The other end portion of the first elastic member 513 is connected to an upper surface of the movable part 53. The first elastic member 513 presses the movable part 53 in a direction in which the movable part 53 moves away from the first electromagnet 512, that is, a downward direction in FIG. 1.

In addition, the second elastic member 523 is disposed on an upper surface of the second fixing part 521. The second elastic member 523 is, for example, a coil spring.

The second elastic member 523 has one end portion connected to the second fixing part 521. The other end portion of the second elastic member 523 is connected to a lower surface of the movable part 53. The second elastic member 523 presses the movable part 53 in a direction in which the movable part 53 moves away from the second electromagnet 522, that is, an upward direction in FIG. 1.

The movable part 53 is pressed by the first elastic member 513 and the second elastic member 523 as described above, so that, under circumstances where no current flows through the first electromagnet 512 or the second electromagnet 522, the movable part 53 is maintained at a neutral position at which an elastic force of the first elastic member 513 and an elastic force of the second elastic member 523 are balanced, as illustrated in an upper diagram of FIG. 5. This makes it possible to maintain, with a simple configuration, the positions of the fingers 33 in a neutral state.

Further, when the fingers 33 are set to the closed state, and then the current is stopped from passing through the first electromagnet 512, the fingers 33 spontaneously return to the neutral state due to the elastic force of the first elastic member 513. This eliminates the need for additional passage of current and thus makes it possible to reduce a power consumption.

Note that, as the first elastic member 513 and the second elastic member 523, diaphragms or bellows may be used instead of the coil springs. In this case, liquid or compressed air is put into each of the diaphragms or each of the bellows, and the liquid or compressed air is discharged or sucked in each of the diaphragms or each of the bellows. This can cause the movable part 53 to move to the neutral position.

The first fixing part 511 or second fixing part 521 may be further provided with an adjustment screw for adjusting the neutral position in the up-and-down direction. Examples of the adjustment screw include a hexagon socket set screw. With use of the hexagon socket set screw, the first elastic member 513 and the second elastic member 523 can be easily screwed up and down at any time without an adhesive or the like.

The robot controller 20 controls a magnitude of current flowing through the first electromagnet 512 or the second electromagnet 522 with use of the current supplying section 54, so that a degree of opening between the gripping parts 331 is adjusted. The “degree of opening between the gripping parts 331” refers to an opening/closing degree indicating how far the gripping parts 331 of the fingers 33 are apart from each other and/or the gripping force with which the gripping parts 331 grip an object M.

Specifically, the robot controller 20 sets the fingers 33 to the closed state, by supplying current to the first electromagnet 512 with use of the current supplying section 54 and thus causing the position of the movable part 53 to move from the neutral position illustrated in the upper diagram of FIG. 5 toward the first electromagnet 512 as illustrated in the lower diagram of FIG. 5.

In contrast, the robot controller 20 sets the fingers 33 to the open state, by supplying current to the second electromagnet 522 with use of the current supplying section 54 and thus causing the position of the movable part 53 to move from the neutral position illustrated in the upper diagram of FIG. 6 toward the second electromagnet 522 as illustrated in the lower diagram of FIG. 6.

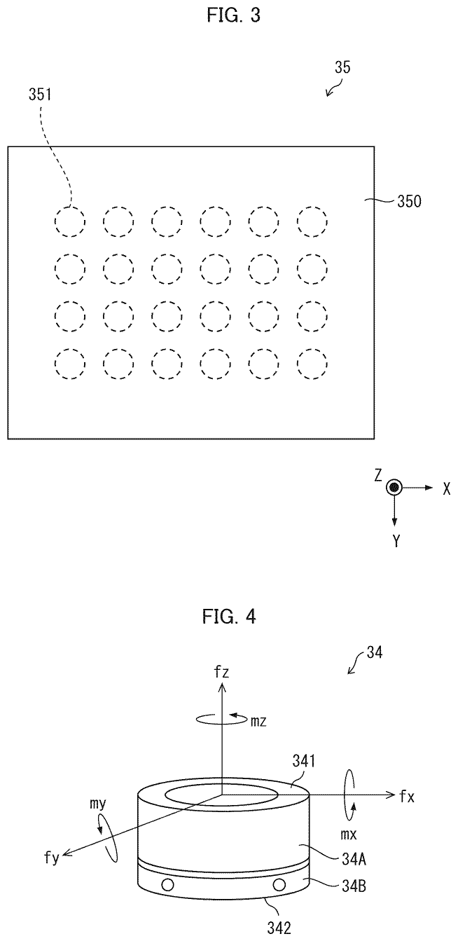

Each of the tactile sensors 35 is, for example, a distributed pressure sensor and includes a flexible member 350 and a plurality of detection elements 351, as illustrated in FIG. 3. The plurality of detection elements 351 are regularly arranged in longitudinal and transverse directions inside the flexible member 350.

When the gripping parts 331 of the fingers 33 grip an object M, the flexible member 350 deforms. In accordance with the deformation of the flexible member 350, the detection elements 351 are displaced. Each of the tactile sensors 35 is a magnetic three-axis tactile sensor configured to perform a three-dimensional tactile detection by detecting, with use of a reading element (not illustrated), a change in a magnetic field due to such displacement of the detection elements 351. Note that each of the tactile sensors 35 is not limited to the magnetic sensor described above but may be, for example, an optical sensor or a sensor having a system in which an MEMS is used.

Each of the tactile sensors 35 detects a deformation amount of the flexible member 350 in tangential directions (that are an x-axis direction and a y-axis direction in FIG. 3) and a normal direction (that is a z-axis direction in FIG. 3). Thus, it is possible to detect forces, torques and the like in the tangential and normal directions. Accordingly, it is possible to detect, for example, (i) sliding of the object M with respect to the gripping parts 331, (ii) hardness and a material of the object M, (iii) a central position and a total weight of a load applied from the object M to the gripping parts 331, and (iv) contact areas between the object M and the gripping parts 331.

The force sensor 34 includes, as illustrated in FIG. 4, a first member 34A having a first surface 341, a second member 34B having a second surface 342, and a strain generator (not illustrated) disposed between the first member 34A and the second member 34B. As illustrated in FIG. 1, the first surface 341 of the force sensor 34 is attached to a tip portion of the robot arm 32, and the second surface 342 of the force sensor 34 is attached to the first fixing part 511.

The force sensor 34 is a six-axis force sensor configured to detect respective directions and respective magnitudes of forces and moments which act on the force sensor 34 itself. Specifically, the force sensor 34 detects the magnitudes of the forces (Fx, Fy, and Fz) acting in directions of three axes (an x axis, a y axis, and a z axis) and the magnitudes of the moments (Mx, My, and Mz) about the three axes. The force sensor 34 and the tactile sensors 35 are each one example of a sensor.

[Configuration of Robot Controller]

The robot controller 20 is an example of a control section and is a device configured to control an operation of the entire robot device 30. As illustrated in FIG. 2, the robot controller 20 includes a processor 21, a memory 22, a communication interface (IF) 23, and an input/output interface (IF) 24. The processor 21, the memory 22, the communication IF 23, and the input/output IF 24 are connected to each other via a bus.

Examples of the processor 21 include a central processing unit (CPU), a graphic processing unit (GPU), a digital signal processor (DSP), a micro processing unit (MPU), or any combination thereof.

The memory 22 stores, for example, a program for controlling the robot arm 32 and the current supplying section 54. The processor 21 controls the robot arm 32 and the current supplying section 54, according to instructions included in the program stored in the memory 22.

The communication IF 23 is an interface for communicating with the control device 10. Examples of the communication IF 23 include interfaces such as Ethernet (registered trademark) and Wi-Fi (registered trademark). Note that the control device 10 may be connected to the input/output IF 24.

The robot arm 32 and the current supplying section 54 are each electrically connected to the input/output IF 24. The robot controller 20 controls the robot arm 32, the first electromagnet 512, and the second electromagnet 522 via the input/output IF 24.

Examples of the input/output IF 24 include a universal serial bus (USB), an advanced technology attachment (ATA), a small computer system interface (SCSI), a serial communication and the like. Note that at least one selected from the group consisting of the robot arm 32, the first electromagnet 512, and the second electromagnet 522 may be connected to the communication IF 23 via a driving section.

[Configuration of Control Device]

The control device 10 is a device configured to perform processes for inferring a gripped state of the object M and the type of the object M. The control device 10 includes a processor 11, a memory 12, a communication IF 13, and an input/output IF 14. The processor 11, the memory 12, the communication IF 13 and the input/output IF 14 are connected to each other via a bus. The processor 11 is configured similarly to the processor 21.

The memory 12 stores, for example, a program that the processor 11 is caused to execute and various trained models. The trained models include a gripped state inference trained model, a type inference trained model, and a control trained model each of which will be described later. Each of the trained models is generated through machine learning. Further, each of the trained models is configured to perform evaluation and determination on the basis of inputted data and then to output, as an output value, the result of the evaluation and determination.

The communication IF 13 is an interface for communicating with the robot controller 20. The input/output IF 14 is configured to include an operation panel that allows a user to perform various settings. Note that the input/output IF 14 may be disposed in the robot controller 20.

[Flow of Control of Robot Device]

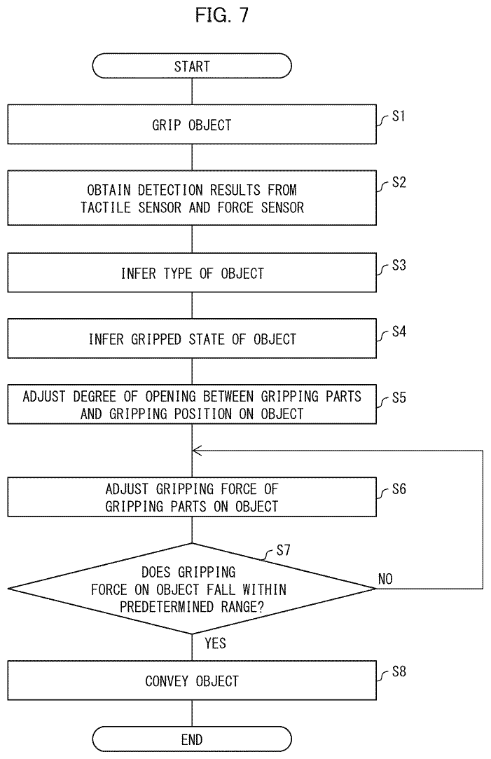

Next, with reference to FIG. 7, the following will describe a flow of control of the robot device 30. FIG. 7 is a flowchart showing an example of the flow of the control of the robot device 30 when the robot device 30 grips an object M.

As illustrated in FIG. 7, first, the robot controller 20 causes a position of the robot arm 32 to move and then to cause the fingers 33 to open and close, so that the gripping parts 331 grip the object M (S1).

In S1, the processor 21 of the robot controller 20 transmits control information to a driving section for driving each of the connection parts of the robot arm 32 so as to cause the position of the robot arm 32 to move. This causes the fingers 33 to move to a gripping position on the object M.

While causing the tip portion of the robot arm 32 to move up and down, the processor 21 controls a magnitude of current flowing through the first electromagnet 512 or the second electromagnet 522 and thus causes the fingers 33 to open and close. Accordingly, the gripping parts 331 grip the object M.

Specifically, the processor 21 supplies current to the first electromagnet 512 with use of the current supplying section 54 and thus changes the state of the fingers 33 from the neutral state illustrated in the upper diagram of FIG. 5 to the closed state illustrated in the lower diagram of FIG. 5.

Accordingly, the gripping parts 331 grip the object M.

When the current flows through the first electromagnet 512, magnetic attraction of the first electromagnet 512 causes the movable part 53 to move toward the first electromagnet 512. In accordance with such movement of the movable part 53, the cam followers 332 rotate in a first direction (see arrows A in the lower diagram of FIG. 5). Accordingly, the closing operation is performed in which the gripping parts 331 of the fingers 33 move closer to each other, so that the fingers 33 are set to the closed state.

After S1, the robot controller 20 obtains detection results inputted from the tactile sensors 35 and the force sensor 34 into the input/output IF 14 of the control device 10 (S2). In S2, the robot controller 20 detects, for example, a weight of the object M with use of the force sensor 34. In addition, the robot controller 20 detects, with use of the tactile sensors 35, for example, (i) sliding of and a material of the object M, (ii) a central position and a total weight of a load applied from the object M to the gripping parts 331, and (iii) contact areas between the object M and the gripping parts 331.

As described above, the robot controller 20 can calculate the weight of the object M on the basis of the detection result from the force sensor 34 and thus can measure the weight of the object M when the object M is lifted with use of the gripping parts 331. This eliminates the need for gripping the object M only in order to measure the weight of the object M, and thus it is possible to reduce the possibility that the fingers 33 and the object M break due to the increased number of times of gripping the object M.

Subsequently, the robot controller 20 infers a type of the object M on the basis of the detection results from the tactile sensors 35, the detection result from the force sensor 34, and the type inference trained model stored in the memory 12 (S3).

The type inference trained model is obtained through machine learning using, as a training data, a relationship between the detection results from the force sensor 34 and from the tactile sensors 35 and the type of the object M gripped by the fingers 33. The robot controller 20 functions as a type inference section configured to infer the type of the object M.

After S3, the robot controller 20 infers a gripped state of the object M on the basis of the detection result from the force sensor 34, the detection results from the tactile sensors 35, and the gripped state inference trained model stored in the memory 12 (S4).

The gripped state inference trained model is obtained through machine learning using, as a training data, a relationship between the detection results from the force sensor 34 and from the tactile sensors 35 and the gripped state of the object M gripped with use of gripping parts 331. The robot controller 20 functions as a gripped state inference section configured to infer the gripped state of the object M.

In a case where, for example, the detection results have not changed over a predetermined period of time from the start of gripping the object M, the gripped state inference trained model infers that the degree of opening between the gripping parts 331 of the plurality of fingers 33 and the gripping position are appropriate and that the gripped state of the object M is favorable. In contrast, in a case where the detection results have changed significantly from the start of gripping the object M, the gripped state inference trained model infers that sliding of the object M gripped by the gripping parts 331 occurs and that the gripped state of the object M is unfavorable.

Subsequently, the robot controller 20 adjusts (i) the gripping position where the gripping parts 331 grip the object M and (ii) the degree of opening between the gripping parts 331, on the basis of an output obtained by inputting the detection results obtained in S2 from the tactile sensors 35 and the force sensor 34 into a control trained model (S5).

Specifically, the robot controller 20 adjusts the degree of opening between the gripping parts 331 by controlling the magnitude of the current supplied from the current supplying section 54 to the first electromagnet 512 or the second electromagnet 522. Here, it is assumed that the degree of opening is adjusted to be an appropriate degree in accordance with a size, a shape, the gripped state and the like of the object M.

For example, in a case where the degree of opening between the gripping parts 331 is to be increased, the processor 21 of the robot controller 20 supplies current to the second electromagnet 522 with use of the current supplying section 54. When the current flows through the second electromagnet 522, magnetic attraction of the second electromagnet 522 causes the movable part 53 to move toward the second electromagnet 522 as illustrated in FIG. 6. In accordance with such movement of the movable part 53, the cam followers 332 rotate in the second direction (see arrows B in the lower diagram of FIG. 6). Accordingly, the opening operation is performed in which the gripping parts 331 of the fingers 33 move away from each other, so that the fingers 33 are set to the open state. As the degree of opening between the gripping parts 331 increases, the gripping force with which the gripping parts 331 grip the object M becomes smaller.

In addition, the robot controller 20 controls the driving section of the robot arm 32 to control the position of the tip portion of the robot arm 32 and accordingly controls the gripping position where the gripping parts 331 of the fingers 33 grip the object M. In this way, the fingers 33 and the robot arm 32 are accurately controlled in accordance with the type of the object M and the gripped state of the object M, so that the gripping parts 331 can appropriately grip the object M.

After S5, the robot controller 20 controls, with use of the current supplying section 54, the magnitude of the current flowing through the second electromagnet 522 in consideration of the type of the object M inferred in S3. Accordingly, adjusted is the gripping force with which the gripping parts 331 grip the object M (S6). Here, it is assumed that, as the magnitude of the current flowing through the first electromagnet 512 increases, the magnitude of the gripping force on the object M becomes larger.

The object M include various types of objects having different shapes, materials, sizes, weights, hardness, surface properties and the like. The memory 12 stores information indicating a magnitude of the gripping force corresponding to a type of the object M. For example, in a case where an object M is heavy, such an object M needs to be gripped with a stronger gripping force. In a case where an object M is a soft object such as food, such an object M needs to be gripped with a weaker gripping force. In this way, an appropriate magnitude of the gripping force is determined in accordance with the type of the object M.

As described above, the robot controller 20 controls, via the current supplying section 54, the magnitude of the current flowing through the first electromagnet 512 or the second electromagnet 522, so that it is possible to accurately control the magnitude of the gripping force with which the gripping parts 331 grip the object M. This can prevent a situation where the object M drops and breaks due to an excessively weak gripping force with which the gripping parts 331 grip the object M and a situation where the fingers 33 break due to an excessively strong gripping force with which the gripping parts 331 grip the object M.

After S6, the robot controller 20 determines whether the gripping force on the object M falls within a predetermined range (S7). In a case where the robot controller 20 determines that the gripping force on the object M falls outside the predetermined range (S7: NO), the process returns to S6. Note that, in S7, the “predetermined range” corresponds to a value(s) calculated on the basis of a magnitude of the gripping force applied when an object M has been gripped most recently or magnitudes of the respective gripping forces applied when a plurality of objects M have been gripped in the past.

As described above, the robot controller 20 controls the magnitude of the current flowing through the first electromagnet 512 or the second electromagnet 522 so that, in S7, the magnitude of the gripping force detected by the tactile sensors 35 falls within the predetermined range. Thus, it is possible to stably grip the object M.

In a case where the gripping force for the object M falls within the predetermined range (S7: YES), the robot controller 20 controls, while making the gripping force on the object M constant, the position of the robot arm 32 so as to convey the object M to a desired position (S8).

Specifically, the processor 11 of the control device 10 transmits a destination position of the object M to the robot controller 20. The processor 21 of the robot controller 20 causes, while making the magnitude of the current flowing through the first electromagnet 512 constant, the robot arm 32 to move to convey the object M to a desired position.

### OTHER EMBODIMENTS

In the embodiment described above, the robot hand 50 has the two fingers 33. However, the robot hand 50 is not limited to this and may have, for example, three or more fingers 33. In addition, the shapes of the fingers 33 can be changed as appropriate.

Further, in the embodiment described above, the force sensor 34 is attached between the robot arm 32 and the first fixing part 511. However, the force sensor 34 is not limited to this and may be incorporated in, for example, the robot arm 32 or the finger 33. Further, the robot device 30 only needs to include the tactile sensor 35 and may not include the force sensor 34. Furthermore, a load cell may be used as a sensor in addition to the tactile sensor 35. In this case, the load cell can be used in order to detect an error in value detected by the tactile sensor 35.

### SUPPLEMENTARY NOTE

The present invention is not limited to the embodiments above, but can be altered by a skilled person in the art within the scope of the claims. The present invention also encompasses, in its technical scope, any embodiment derived by combining technical means disclosed in differing embodiments as appropriate.

1. A robot hand comprising:
a plurality of fingers;
a first electromagnet;
a second electromagnet facing the first electromagnet; and
a movable part made of a magnetic material and configured to be movable between the first electromagnet and the second electromagnet,
the plurality of fingers including:
respective gripping parts located at tips of the fingers and configured to grip an object; and
respective rotating parts configured to rotate around rotating shafts in accordance with movement of the movable part,
the respective gripping parts of the plurality of fingers being configured to perform:
a closing operation in which the rotating parts rotate in a first direction in accordance with movement of the movable part toward the first electromagnet with magnetic attraction of the first electromagnet, so that the gripping parts move closer to each other; and
an opening operation in which the rotating parts rotate in a second direction opposite to the first direction in accordance with movement of the movable part toward the second electromagnet with magnetic attraction of the second electromagnet, so that the gripping parts move away from each other.

2. The robot hand according to claim 1, further comprising:
a first fixing part where the first electromagnet is disposed;
a second fixing part where the second electromagnet is disposed;
a first elastic member provided at the first fixing part and configured to press the movable part in a direction in which the movable part moves away from the first electromagnet; and
a second elastic member provided at the second fixing member and configured to press the movable part in a direction in which the movable part moves away from the second electromagnet.

3. The robot hand according to claim 1, wherein the movable part has a concavity where the rotating parts are held.

4. A robot device comprising:
the robot hand according to claim 1; and
a control section configured to control a magnitude of current flowing through the first electromagnet or the second electromagnet,
the control section controlling a degree of opening between the gripping parts by (i) controlling the magnitude of current flowing through the first electromagnet to cause the movable part to move toward the first electromagnet, thereby causing the gripping parts to perform the closing operation and (ii) controlling the magnitude of current flowing through the second electromagnet to cause the movable part to move toward the second electromagnet, thereby causing the gripping parts to perform the opening operation.

5. The robot device according to claim 4, further comprising a sensor configured to be capable of detecting at least one selected from the group consisting of a gripping force with which the gripping parts grip the object, forces acting on the robot hand, and moments acting on the robot hand,
the control section controlling the magnitude of current flowing through the first electromagnet or the second electromagnet on the basis of a detection result from the sensor.

6. The robot device according to claim 5, wherein:
the sensor is a tactile sensor disposed in each of the gripping parts and configured to detect the gripping force; and
the control section controls the magnitude of current flowing through the first electromagnet or the second electromagnet on the basis of a magnitude of the gripping force detected by the tactile sensor.

7. The robot device according to claim 6, wherein the control section controls the magnitude of current flowing through the first electromagnet or the second electromagnet so that a magnitude of the gripping force detected by the tactile sensor falls within a predetermined range.

8. The robot device according to claim 5, wherein the control section calculates a weight of the object on the basis of a detection result from the sensor.

9. The robot device according to claim 5, further comprising a gripped state inference section configured to infer a gripped state of the object on the basis of a gripped state inference trained model and a detection result from the sensor,
the gripped state inference trained model being obtained through machine learning using, as training data, a relationship between a detection result from the sensor and the gripped state of the object gripped by the gripping parts,
the control section adjusting (i) a gripping position where the gripping parts grip the object and (ii) the degree of opening between the gripping parts, by controlling the magnitude of current flowing through the first electromagnet or the second electromagnet on the basis of the gripped state of the object inferred by the gripped state inference section.

10. The robot device according to claim 5, further comprising a type inference section configured to infer a type of the object on the basis of a type inference trained model and a detection result from the sensor,
the type inference trained model being obtained through machine learning using, as training data, a relationship between a detection result from the sensor and the type of the object,
the control section adjusting (i) a gripping position where the gripping parts grip the object and (ii) the degree of opening between the gripping parts, by controlling the magnitude of current flowing through the first electromagnet or the second electromagnet on the basis of the type of the object inferred by the type inference section.

11. The robot device according to claim 5, wherein the control section adjusts (i) a gripping position where the gripping parts grip the object and (ii) the degree of opening between the gripping parts, on the basis of an output obtained by inputting a detection result from the sensor into a control trained model obtained through machine learning.
